(19) United States
(12) Patent Application Publication
(10) Pub. No.: US 2015/0346735 A1
(43) Pub. Date: Dec. 3, 2015

(54) DUMPING WELL

(71) Applicant: Robert Carl Rajewski, Forestburg (CA)

(72) Inventor: Robert Carl Rajewski, Forestburg (CA)

(21) Appl. No.: 14/291,517

(22) Filed: May 30, 2014

(51) Int. Cl. G05D 9/02

(52) U.S. Cl. CPC G05D 9/02

(57) ABSTRACT

A dumping well including a tank, upper and lower liquid level detectors, and a dump valve operated by pressurized fluid. The dumping well dumps liquid from the tank in response to liquid reaching an upper liquid level and ceases dumping liquid upon the liquid reaching a lower liquid level.

### TECHNICAL FIELD

Dumping well apparatus and dumping method

### BACKGROUND

In a typical dumping well arrangement a displacer is suspended in a tank. When the fluid level rises in the tank fluid buoyancy lifts the displacer plugging an orifice in a control box attached to the tank. While open the orifice bleeds off a supply of pressurized gas, such as pressurized air or natural gas, and once the orifice is plugged there is a build-up of pressure which opens a dump valve connected to the tank. Opening the dump valve allows fluid to exit the tank, causing the fluid level to fall along with the displacer. The lowering of the displacer opens the orifice in the control box, allowing the pressurized air to vent out, releasing the built-up pressure and allowing the dump valve to close. This procedure cycles frequently, dumping only small volumes of fluid on each cycle and wasting large volumes of pressurized gas.

### SUMMARY

In an embodiment, there is disclosed a dumping well comprising a tank for containing a liquid, an upper liquid level detector for detecting an upper liquid level in the tank, a lower liquid level detector for detecting a lower liquid level in the tank, a dump valve for dumping liquid from the tank and a control system for opening the dump valve in response to the upper liquid level detector detecting an upper liquid level in the tank, and for closing the dump valve in response to the lower liquid level detector detecting a lower liquid level in the tank, in which the dump valve is operated by a pressurized fluid, and the control system is configured to open the dump valve by opening a control valve connecting the dump valve to a supply of pressurized fluid and to close the dump valve by closing the control valve.

In various embodiments, there may be included any one or more of the following features: the control valve may be a solenoid valve, the solenoid valve may be a pulse solenoid valve, the control system is a flip flop relay connected to control the pulse solenoid valve, there may be a float and the upper liquid level detector and lower liquid detector may be configured to detect the level of the liquid by detecting the level of the float, the float may be in a float bridle connected to the tank, the float bridle may have at least an upper and lower connection to the tank, the upper and lower liquid level detectors may be magnetic proximity detectors and the float may comprise a magnet, the float bridle may be substantially non-magnetic and may be made of stainless steel, there may be a flow rate valve connected to an outlet of the dump valve and the flow rate valve may be a globe valve, the supply of pressurized fluid may be a pressurized air tank, the pressurized air tank may be supplied with pressurized air from an air compressor, the air compressor may be powered by a solar panel.

In an embodiment there is disclosed a method of dumping a liquid from a tank comprising detecting the liquid reaching an upper liquid level, operating a dump valve with pressurized fluid in response to the liquid reaching a first liquid level, detecting the liquid reaching a lower liquid level and closing the dump valve in response to the liquid reaching the second liquid level. In a further embodiment the pressurized fluid is pressurized air and in a further embodiment the pressurized fluid is pressurized gas.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a schematic of an exemplary dumping well configuration.

FIG. 2 is a schematic of a pressurized gas tank with an air compressor and solar panel.

### DETAILED DESCRIPTION

Immaterial modifications may be made to the embodiments described here without departing from what is covered by the claims.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

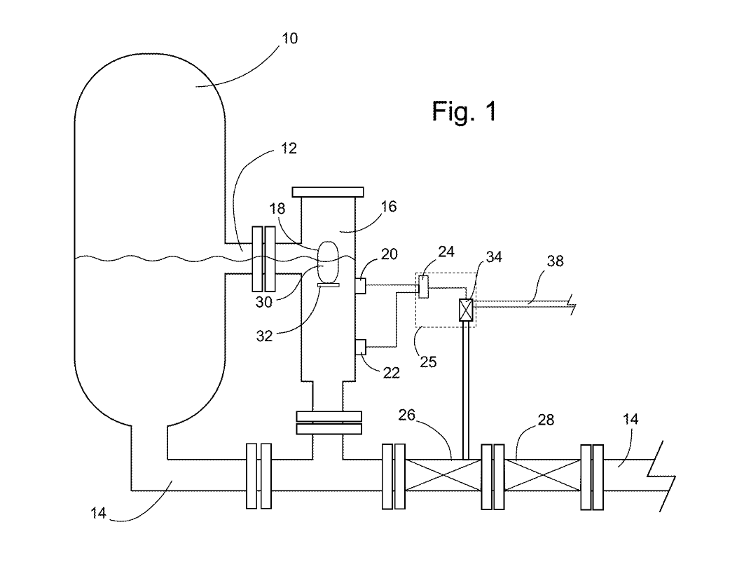

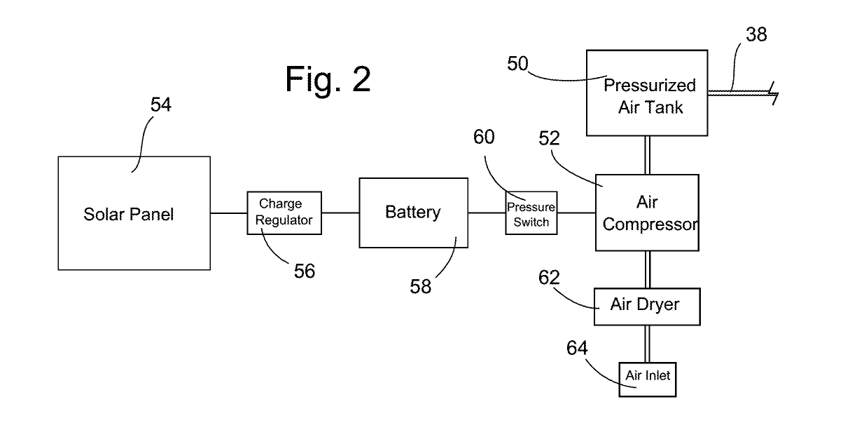

Referring to FIG. 1, there is shown a tank 10 containing liquid to be dumped. The tank 10 is connected by upper pipe 12 to a float bridle 16 containing a float 18. The float 18 may include a flotation component 30 and a permanent magnet component 32. In an embodiment the float is a pressurized canister float with a permanent magnet clamped to its bottom end. The float is pre-pressurized to prevent it from being crushed at operating pressures. Associated with float bridle 16 is an upper liquid level detector 20 and a lower liquid level detector 22. In this shown embodiment the upper and lower liquid level detectors are magnetic proximity detectors. The upper liquid level detector and the lower liquid level detector connect to a control system 25 which controls a flow of pressurized air to open the dump valve in response to the upper liquid level detector detecting an upper liquid level in the tank, and close the dump valve in response to the lower liquid level detector detecting a lower liquid level in the tank. The control system 25 may comprise a control switch 24 which controls an air flow control valve 34. In a preferred embodiment the control switch 24 is a flip-flop relay switch and the air flow control valve 34 is a pulse solenoid valve. In this embodiment the air flow control valve 34 controls air flow through tube 38 from a pressurized air tank 50 (shown in FIG. 2) to a dump valve 26. The air flow control valve 34 may be a three way valve configured to allow air flow from the pressurized air tank 50 when the air flow control valve 34 is open and to bleed air pressure between the air flow control valve 34 and the dump valve 26 when closed. The dump valve 26 receives fluid through lower pipe 14 from tank 10 and float bridle 16. The outlet of dump valve 26 is also connected by lower pipe 14 to flow rate valve 28. The flow rate valve throttles the flow of fluid through lower pipe 14 and, in a preferred embodiment, the flow rate valve 28 is a globe valve. A generic valve symbol is used in FIG. 1 to represent each of the dump valve 26, flow rate valve 28, air flow control valve 34 and bleed valve 36.

Referring to FIG. 2, there is shown a pressurized air tank 50 which receives pressurized air from an air compressor 52 through tube 38. The air compressor 52 is powered by a solar panel 54 and associated with the solar panel 54 is a charge regulator 56 and a battery 58. Although a solar panel arrangement is shown, many conventional power sources could be used to power the air compressor. The air compressor 52 is controlled by a pressure switch 60 which activates the air compressor 52 upon detecting that the air pressure in the pressurized air tank 50 is below a lower threshold and deactivates the air compressor upon detecting that the air pressure in the tank is above an upper threshold. In the figure an air dryer 62 is connected to an air inlet 64 and the air compressor 52. The air dryer 62 serves to remove moisture from the intake air and, in one preferred embodiment, is a desiccant bead air dryer.

During operation of the dumping well, the dump valve 26 starts in a closed position. Liquid enters the tank 10 raising the liquid level in the tank 10. Upper pipe 12 and lower pipe 14 connect the tank 10 and float bridle 16, allowing equalization of liquid level. The float 18 rises with the liquid level in the float bridle 16 and is eventually detected by the upper liquid level detector 20. The upper liquid level detector then triggers control switch 24. The control switch 24 switches the air flow control valve 34 from a closed position to an open position and switches the bleed valve 36 from an open position to a closed position. Opening the air flow control valve 34 allows pressurized air from the pressurized air tank 50 to travel through tube 38 to the dump valve 26. The pressurized air moves the dump valve 26 from a closed position to an open position and allows liquid to exit the tank 10 and float bridle 16 through the lower pipe 14. A flow rate valve 28 limits the rate at which liquid is able to exit through pipe 14. The degree to which the flow rate valve 28 reduces the flow rate should be calibrated to ensure that there is no net flow into the tank 10 when the dump valve 26 is open.

As liquid exits the tank 10 and float bridle 16 the liquid level falls and with it the float 18. When the float reaches the level of the lower liquid level detector 22, the detector 22 triggers the control switch 24 which now closes the air flow control valve 34 and opens the bleed valve 36. Opening the bleed valve 36 allows bleeding of air pressure at the dump valve 26, prompting the dump valve 26 to close and therefore preventing liquid from exiting the tank 10 and fluid well 14. Further liquid entering the tank 10 will then cause the liquid level to rise, allowing the process to repeat.

While the system is described as using pneumatic power to control the dump valve, it would be apparent that hydraulic power could be used to accomplish a similar result.

The embodiments of the invention in which an exclusive property or privilege is claimed are defined as follows:

1. A dumping well comprising:
a tank for containing a liquid;
an upper liquid level detector for detecting an upper liquid level in the tank;
a lower liquid level detector for detecting a lower liquid level in the tank;
a dump valve for dumping liquid from the tank; and
a control system for opening the dump valve in response to the upper liquid level detector detecting an upper liquid level in the tank, and for closing the dump valve in response to the lower liquid level detector detecting a lower liquid level in the tank;
in which the dump valve is operated by a pressurized fluid, and the control system is configured to open the dump valve by opening a control valve connecting the dump valve to a supply of pressurized fluid and to close the dump valve by closing the control valve.

2. The dumping well of claim 1 in which the control valve is a solenoid valve.

3. The dumping well of claim 2 in which the solenoid valve is a pulse solenoid valve.

4. The dumping well of claim 3 in which the control system is a flip flop relay connected to control the pulse solenoid valve.

5. The dumping well of claim 1 further comprising a float and the upper liquid level detector and lower liquid level detector being configured to detect the level of the liquid by detecting the level of the float.

6. The dumping well of claim 5 in which the float is in a float bridle connected to the tank.

7. The dumping well of claim 6 in which the float bridle has at least an upper connection and at least a lower connection to the tank.

8. The dumping well of claim 7 in which the upper liquid level detector and the lower liquid level detectors are magnetic proximity detectors and the float comprises a magnet.

9. The dumping well of claim 8 in which the float bridle is substantially non-magnetic.

10. The dumping well of claim 9 in which the float bridle is substantially made of non-magnetic stainless steel.

11. The dumping well of claim 1 further comprising a flow rate valve connected to an outlet of the dump valve, the flow rate valve being configured to control the liquid flow rate.

12. The dumping well of claim 11 in which the flow rate valve is a globe valve.

13. The dumping well of claim 1 in which the supply of pressurized fluid is a pressurized air tank.

14. The dumping well of claim 13 in which the pressurized air tank is supplied with pressurized air from an air compressor.

15. The dumping well of claim 14 in which the air compressor is powered by a solar panel.

16. A method of dumping a liquid from a tank comprising:
detecting the liquid reaching an upper liquid level;
operating a dump valve with pressurized fluid in response to the liquid reaching the upper liquid level;
detecting the liquid reaching a lower liquid level; and
closing the dump valve in response to the liquid reaching the lower liquid level.

17. The method of claim 16 in which the pressurized fluid is pressurized air.

18. The method of claim 16 in which the pressurized fluid is pressurized gas.
